(19) United States
(12) Patent Application Publication
(10) Pub. No.: US 2013/0041793 A1
(43) Pub. Date: Feb. 14, 2013

(54) FINANCIAL DATA PROCESSING DEVICE, FINANCIAL DATA PROCESSING METHOD, AND COMPUTER-READABLE RECORDING MEDIUM

(71) Applicant: FUJITSU LIMITED, Kawasaki-shi (JP)

(72) Inventors: Kazunori Kashima, Kawasaki (JP); Yoshiki Sugino, Kawasaki (JP); Masatoshi Hashimoto, Yokohama (JP)

(73) Assignee: FUJITSU LIMITED, Kawasaki-shi (JP)

(21) Appl. No.: 13/654,886

(22) Filed: Oct. 18, 2012

Related U.S. Application Data
(63) Continuation of application No. PCT/JP2011/055283, filed on Mar. 7, 2011.

(30) Foreign Application Priority Data
Apr. 21, 2010 (JP) 2010-098235

(51) Int. Cl. G06Q 40/00

(52) U.S. Cl. 705/30

(57) ABSTRACT

A financial data processing device generates common data, and thereafter, converts the common data into XBRL-FR format financial statements, and an XBRL-GL format trial balance and an XBRL-GL format itemized statement, which are related to the financial statements, on the basis of a mapping table which indicates a relationship among a template of XBRL-FR format financial statements, a template of an XBRL-GL format trial balance and an XBRL-GL format itemized statement, and areas in which the common items are located on the templates, and stores the XBRL-FR format financial statements, the XBRL-GL format trial balance, and the XBRL-GL format itemized statement in a storage unit.

### CROSS-REFERENCE TO RELATED APPLICATIONS

This application is a continuation of International Application No. PCT/JP2011/055283, filed on Mar. 7, 2011 which claims the benefit of priority of the prior Japanese Patent Application No. 2010-098235, filed on Apr. 21, 2010, the entire contents of which are incorporated herein by reference.

### FIELD

The embodiments discussed herein are directed to a financial data processing device and the like.

### BACKGROUND

A financier analyzes finance related information including various information related to finance of a company and determine whether or not to finance the company. For example, the financier acquires finance related information outputted from an accounting system of the company and inputs the acquired finance related information into a financial analysis system, so that the financier analyzes the financial condition of the company. These related-art examples are described, for example, in

Japanese Laid-open Patent Publication No. 2006-259792,

Japanese Laid-open Patent Publication No. 2003-16261.

However, it is not possible for the conventional technique described above to uniformly process company-unique finance related information, so that there is a problem that the financier does not quickly and appropriately finance the company.

Generally, a company uses a unique accounting system, so that a data format of the finance related information outputted from each accounting system is not a unified data format. Therefore, the financier needs to convert the finance related information acquired from each company into a predetermined format and manually input the converted information into a financial analysis system, so that the financier cannot quickly analyze the finance related information.

The finance related information outputted from an accounting system closely related to trial balance and itemized statement outputted from a company-unique business system. Therefore, the financier can determine whether or not there is a fraud in the finance related information when the financier compares the trial balance and itemized statement with the finance related information. However, each company uses a unique business system of its own, so that if the financier checks the trial balance, the itemized statement, and the finance related information for each company one by one, it takes huge time and cost. Therefore, the financier cannot help but determine whether or not to finance a company assuming that there is no fraud in the finance related information.

### SUMMARY

According to an aspect of an embodiment, a financial data processing device includes a storage device stores items included in data of financial statements, a trial balance, and an itemized statement outputted from each of accounting software applications and common items among a plurality of accounting software applications in association with each other; and a processor coupled to the storage devices, wherein the processor executes a process comprising: generating common data obtained by converting items included in data of financial statements, a trial balance, and an itemized statement outputted from one accounting software application of the plurality of accounting software applications into common items among the plurality of accounting software applications and which are stored in the storage device in association with items of the financial statements, the trial balance, and the itemized statement outputted from the one accounting software application; converting the common data into XBRL-FR format financial statements, and an XBRL-GL format trial balance and an XBRL-GL format itemized statement, which are related to the financial statements, on the basis of a mapping table which indicates a relationship among a template of XBRL-FR format financial statements, a template of an XBRL-GL format trial balance and an XBRL-GL format itemized statement, and areas in which the common items are located on the templates; and storing the XBRL-FR format financial statements, the XBRL-GL format trial balance, and the XBRL-GL format itemized statement in the storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration of a financial data processing device;

FIG. 2 is a diagram illustrating a configuration of a system according to a second embodiment;

FIG. 3 is a functional block diagram illustrating a configuration of an XBRL management device;

FIG. 4 is a diagram (1) for explaining a processing of a common data generator;

FIG. 5 is a diagram illustrating a data structure of attached information;

FIG. 6 is a diagram illustrating a data structure of application management information;

FIG. 7 is a diagram (1) illustrating a data structure of format definition information;

FIG. 8 is a diagram illustrating a relationship between business data and common business data;

FIG. 9 is a diagram (2) for explaining the processing of the common data generator;

FIG. 10 is a diagram (2) illustrating the data structure of the format definition information;

FIG. 11 is a diagram illustrating a relationship between accounting data and common accounting data;

FIG. 12 is a diagram (3) for explaining the processing of the common data generator;

FIG. 13 is a diagram for explaining a processing of a first format converter;

FIG. 14 is a diagram illustrating a data structure of an accounting item correspondence table;

FIG. 15 is a diagram (1) illustrating a data structure of an accounting item management table;

FIG. 16 is a diagram illustrating a data structure of intermediate common business data;

FIG. 17 is a diagram illustrating a relationship among the business data, the common business data, the intermediate common business data, and XBRL-GL data;

FIG. 18 is a diagram for explaining a processing of a second format converter;

FIG. 19 is a diagram (1) for explaining a processing of a third format converter;

FIG. 20 is a diagram (2) illustrating the data structure of the accounting item management table;

FIG. 21 is a diagram illustrating a data structure of supplementary information;

FIG. 22 is a diagram illustrating a data structure of FR template information;

FIG. 23 is a diagram illustrating a data structure of XBRL-FR data;

FIG. 24 is a diagram (1) illustrating an example of a screen outputted by a financial institution linkage function unit;

FIG. 25 is a diagram (2) illustrating an example of a screen outputted by the financial institution linkage function unit;

FIG. 26 is a flowchart illustrating a processing procedure of the XBRL management device;

FIG. 27 is a flowchart illustrating a procedure for converting the business data into the XBRL-GL data;

FIG. 28 is a flowchart illustrating a procedure for converting the XBRL-GL data into the accounting data;

FIG. 29 is a flowchart illustrating a procedure for converting the accounting data into the XBRL-FR data; and

FIG. 30 is a diagram illustrating a hardware configuration of a computer that configures the XBRL management device according to the embodiment.

### DESCRIPTION OF EMBODIMENTS

Preferred embodiments of the present invention will be explained with reference to accompanying drawings. The present invention is not limited by the embodiments.

### [a] First Embodiment

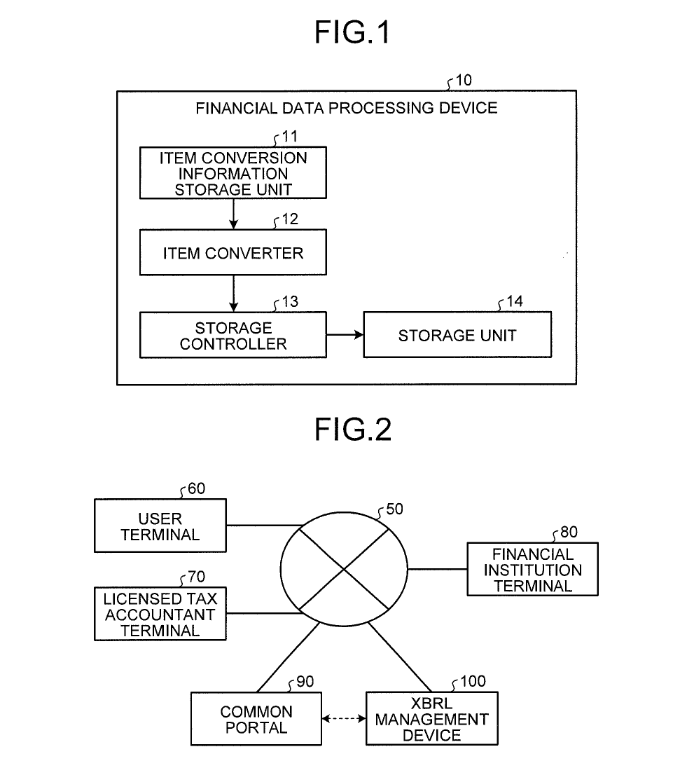

FIG. 1 is a diagram illustrating a configuration of a financial data processing device according to a first embodiment. As illustrated in FIG. 1, a financial data processing device 10 includes an item conversion information storage unit 11, an item converter 12, a storage controller 13, and a storage unit 14.

The item conversion information storage unit 11 stores items included in data of financial statements, a trial balance, and an itemized statement outputted from each of the accounting software applications and common items among a plurality of accounting software applications in association with each other.

The item converter 12 generates common data obtained by converting items included in data of financial statements, a trial balance, and an itemized statement outputted from one accounting software application of the plurality of accounting software applications into items which are common among the plurality of accounting software applications and which are stored in the item conversion information storage unit 11 in association with items of the financial statements, the trial balance, and the itemized statement outputted from the one accounting software application.

The storage controller 13 converts the common data into XBRL-FR format financial statements, and an XBRL-GL format trial balance and an XBRL-GL format itemized statement, which are related to the financial statements, on the basis of a mapping table which indicates a relationship among a template of XBRL-FR format financial statements, a template of an XBRL-GL format trial balance and an XBRL-GL format itemized statement, and areas in which the common items are located on the templates, and stores the XBRL-FR format financial statements, the XBRL-GL format trial balance, and the XBRL-GL format itemized statement in the storage unit 14.

According to the financial data processing device 10 of the first embodiment, it is possible to uniformly process company-unique financial related information, so that a financier can quickly and appropriately finance a company.

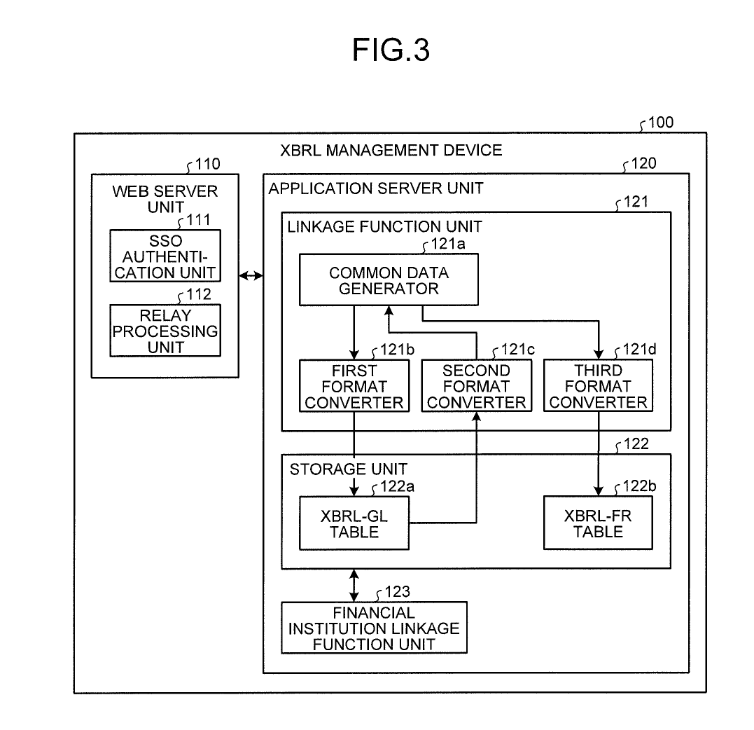

The financial data processing device 10 corresponds to an XBRL management device 100 in FIG. 3 described later. The item converter 12 corresponds to a common data generator 121a in FIG. 3. The storage controller 13 corresponds to a first format converter 121b and a third format converter 121d in FIG. 3. The item conversion information storage unit 11 and the storage unit 14 correspond to, for example, a storage unit 122 in FIG. 3.

### [b] Second Embodiment

Next, a configuration of a system according to a second embodiment will be described. FIG. 2 is a diagram illustrating the configuration of the system according to the second embodiment. As illustrated in FIG. 2, the system includes a user terminal 60, a licensed tax accountant terminal 70, a financial institution terminal 80, a common portal 90, an XBRL (eXtensible Business Reporting Language) management device 100. The devices 60 to 100 are connected to a network 50.

The user terminal 60 is a terminal used, for example, when an employee of a small or medium-sized company inputs information related to finance. The employee logs in to the common portal 90 by using the user terminal 60 and, for example, inputs information related to financial statements, a trial balance, and an itemized statement and manages information related to finance of the company. For example, the user terminal 60 uses a function of the common portal 90 online by SaaS (Software as Service). The user terminal 60 transmits information such as financial statements, a trial balance, and an itemized statement to the XBRL management device 100.

The licensed tax accountant terminal 70 is, for example, a terminal used by a licensed tax accountant who contracts with a small or medium-sized company. The licensed tax accountant acquires information related to finance applied by the company by using the licensed tax accountant terminal 70 and checks the information. Then, the licensed tax accountant transmits an examination result to the XBRL management device 100 by using the licensed tax accountant terminal 70.

The financial institution terminal 80 is, for example, a terminal used by a financier who finances a small or medium-sized company. The financier acquires information for making a decision whether or not to finance the company from the XBRL management device 100 by using the financial institution terminal 80.

The common portal 90 is a device which provides various functions to the user terminal 60 online by SaaS. For example, when the common portal 90 receives information such as a trial balance and an itemized statement which are components of the financial statements from the user terminal 60, the common portal 90 transmits the information such as the trial balance and the itemized statement to the XBRL management device 100. In the description below, the information (journalized data) which is components of the financial statements such as the trial balance and the itemized statement transmitted by the common portal 90 to the XBRL management device 100 is represented as “business data”.

The XBRL management device 100 is a device which manages financial information of each company by XBRL, which is a standard data format. Specifically, when the XBRL management device 100 acquires business data from the common portal 90, the XBRL management device 100 converts the business data into a standard data format, converts the converted data into XBRL-GL (Global Ledger) data, and stores the XBRL-GL data in an XBRL-GL table. Then, the XBRL management device 100 generates “accounting data” corresponding to a data format of a predetermined accounting package on the basis of the XBRL-GL data stored in the XBRL-GL table.

Further, the XBRL management device 100 converts the accounting data of the predetermined accounting package into a standard data format, converts the converted data into XBRL-FR (Financial Report) data, and stores the XBRL-FR data in an XBRL-FR table.

When the XBRL management device 100 receives an information request related to finance from the financial institution terminal 80 or the like, the XBRL management device 100 provides the data converted into the XBRL-GL format or the XBRL-FR format along with a check result of the licensed tax accountant to the financial institution terminal 80.

Next, an example of a configuration of the XBRL management device 100 illustrated in FIG. 2 will be described. FIG. 3 is a functional block diagram illustrating the configuration of the XBRL management device. As illustrated in FIG. 3, the XBRL management device 100 includes a web server unit 110 and an application server unit 120.

The web server unit 110 is, for example, a processing unit which performs an SSO (Single Sign On) authentication and various relaying processings. As illustrated in FIG. 3, the web server unit 110 includes an SSO authentication unit 111 and a relay processing unit 112.

The SSO authentication unit 111 is a processing unit which performs an SSO authentication when receiving access from the user terminal 60, the licensed tax accountant terminal 70, or the financial institution terminal 80. The SSO authentication unit 111 allows only a terminal which is successfully authenticated to access the application server unit 120.

The relay processing unit 112 is a processing unit which relays data transmitted and received between the common portal 90 and an application. For example, the relay processing unit 112 outputs business data transmitted from the common portal to the application server unit 120.

The application server unit 120 is a processing unit which manages business data, accounting data, and the like in the XBRL data format. As illustrated in FIG. 3, the application server unit 120 includes a linkage function unit 121, a storage unit 122, and a financial institution linkage function unit 123.

The linkage function unit 121 is a processing unit that controls linkage which generates accounting data after converting business data into the XBRL data format and converts the accounting data into the XBRL data format. In this way, the linkage function unit 121 controls linkage which converts business data into the XBRL data format and generates accounting data by using the converted data. Therefore, it is possible to guarantee that data of the financial statements is certainly generated from data of the trial balance and the itemized statement, so that the financial condition of the company can be clarified.

The linkage function unit 121 converts business data into common business data, and thereafter, converts the data format of the common business data into a data format corresponding to the XBRL and generates XBRL-GL data. The XBRL-GL data includes, for example, information of the trial balance and the itemized statement.

The linkage function unit 121 converts the XBRL-GL data into common accounting data, and thereafter, generates accounting data. The linkage function unit 121 converts the accounting data into the common accounting data, and thereafter, converts the data format of the common accounting data into the data format corresponding to the XBRL and generates XBRL-FR data and XBRL-GL data. The XBRL-FR data includes, for example, information of the financial statements.

The linkage function unit 121 includes a common data generator 121a, a first format converter 121b, a second format converter 121c, and a third format converter 121d.

The common data generator 121a converts the business data into the common business data, and thereafter, outputs the common business data to the first format converter 121b. The common data generator 121a also converts the common accounting data outputted from the second format converter 121c into the accounting data. The common data generator 121a also converts the accounting data into the common accounting data, and thereafter, outputs the common accounting data to the third format converter 121d.

The first format converter 121b converts the common business data into the XBRL-GL data and stores the XBRL-GL data in an XBRL-GL table 122a.

The second format converter 121c converts the XBRL-GL data into the common accounting data and outputs the common accounting data to the common data generator 121a. The third format converter 121d converts the common accounting data into the XBRL-FR data and stores the XBRL-FR data in an XBRL-FR table 122b.

The storage unit 122 is a storage unit which stores the XBRL-GL table 122a and the XBRL-FR table 122b.

The financial institution linkage function unit 123 is a processing unit which notifies the financial institution terminal 80 of the XBRL-FR data stored in the XBRL-FR table 122b and the XBRL-GL data stored in the XBRL-GL table 122a. The financial institution linkage function unit 123 holds an examination result of the licensed tax accountant transmitted from the licensed tax accountant terminal 70 and also notifies the financial institution terminal 80 of the examination result.

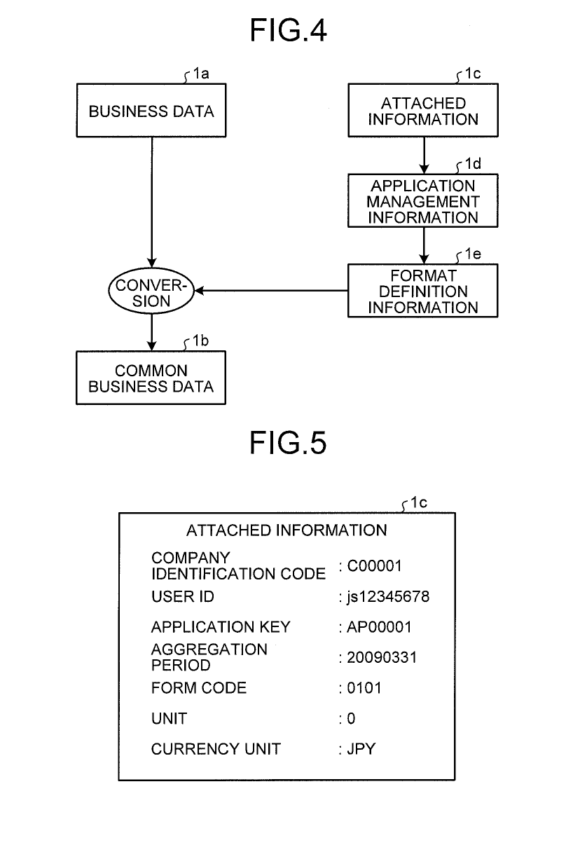

Next, the processing of the common data generator 121a will be specifically described. First, the processing when the common data generator 121a converts the business data into the common business data will be described. FIG. 4 is a diagram (1) for explaining the processing of the common data generator. As illustrated in FIG. 4, the common data generator 121a converts business data 1a to common business data 1b on the basis of attached information 1c, application management information 1d, and format definition information 1e. The common data generator 121a holds the attached information 1c, the application management information 1d, and the format definition information 1e.

The attached information 1c is information including a company identification code for identifying a company, an application key for uniquely identifying a business package used by a company, and the like. FIG. 5 is a diagram illustrating a data structure of the attached information. As illustrated in FIG. 5, the attached information 1c includes a company identification code, a user ID, an application key, an aggregation period, a form code, a unit, and a currency unit.

It is assumed that the common data generator 121a holds the attached information for each company. For example, the company identification code is provided to the business data and the common data generator 121a determines corresponding attached information by using the company identification code.

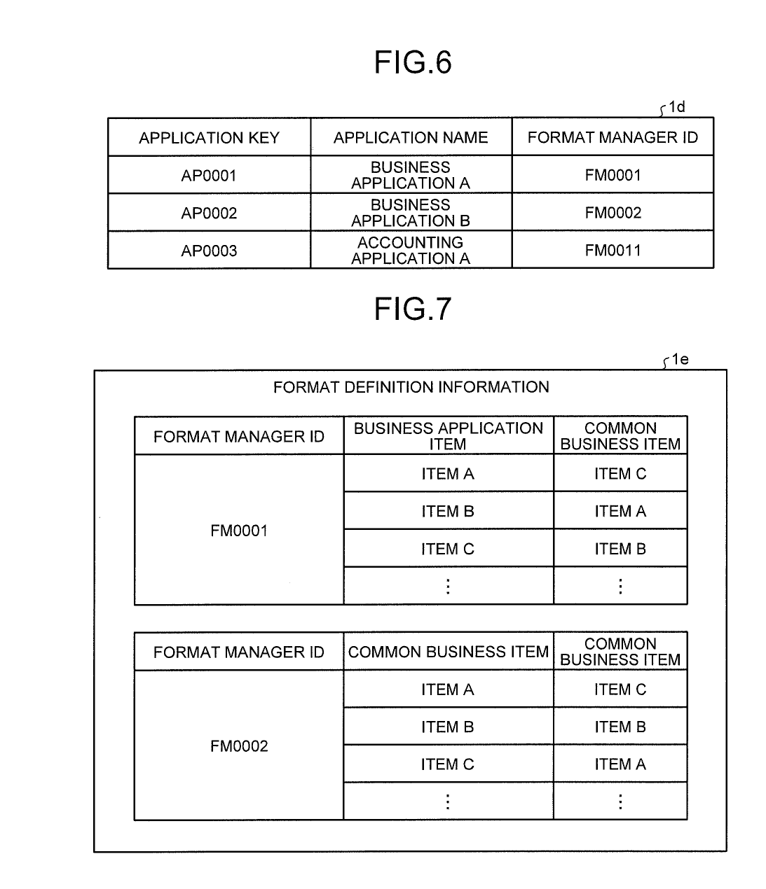

The application management information 1d is a table which stores the application key and a format manager ID for converting the business data and the accounting data into the common business data in association with each other. FIG. 6 is a diagram illustrating a data structure of the application management information. As illustrated in FIG. 6, in the application management information 1d, an application key, an application name, and a format manager ID are stored in association with each other. The format manager ID is used to refer to the format definition information 1e.

The format definition information 1e is information in which items included in the business data 1a and items included in the common business data 1b are associated with each other. Here, an item included in the business data 1a is represented as a business application item and an item included in the common business data 1b is represented as a common business item. FIG. 7 is a diagram (1) illustrating a data structure of the format definition information. As illustrated in FIG. 7, in the format definition information 1e, the format manager ID, the business application items, and the common business items are stored in association with each other. The relationship between the business application items and the common business items is different for each format manager ID.

The common data generator 121a compares the attached information 1c and the application management information 1d and determines the format manager ID corresponding to the application key of the attached information 1c. For example, when the application key of the attached information 1c is “AP0001”, the corresponding format manager ID is “FM0001”.

Subsequently, the common data generator 121a compares the format manager ID and the format definition information 1e and determines the relationship between the business application items and the common business items. For example, when the format manager ID is “FM0001”, the relationship between the business application items and the common business items is the relationship illustrated in the upper part of FIG. 7.

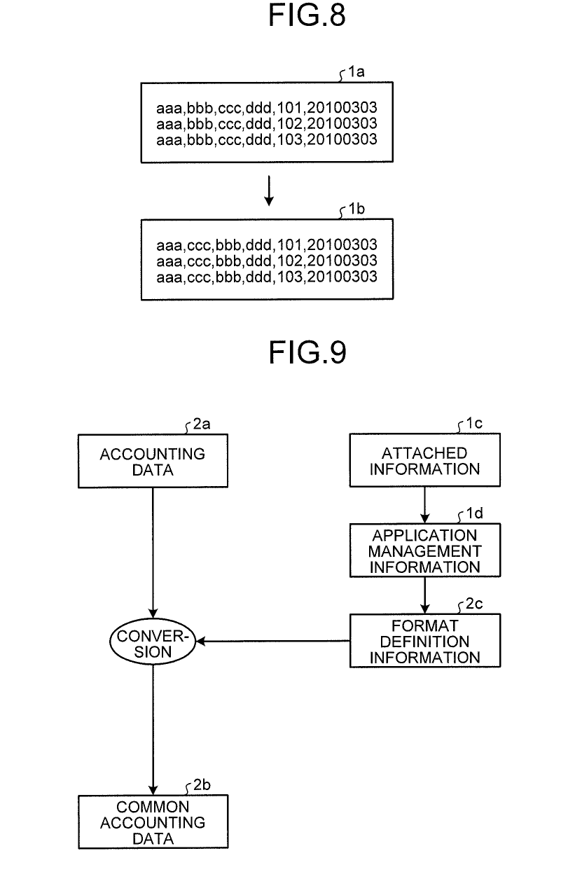

The common data generator 121a compares the relationship between the business application items and the common business items and the business data 1a and generates the common business data 1b by replacing the business application items by the common business items. FIG. 8 is a diagram illustrating a relationship between the business data and the common business data. As illustrated in FIG. 8, application items in the business data 1a are swapped and the common business data 1b is generated.

Next, the processing when the common data generator 121a converts the accounting data into the common accounting data will be described. FIG. 9 is a diagram (2) for explaining the processing of the common data generator. As illustrated in FIG. 9, the common data generator 121a converts accounting data 2a to common accounting data 2b on the basis of the attached information 1c, the application management information 1d, and format definition information 2c.

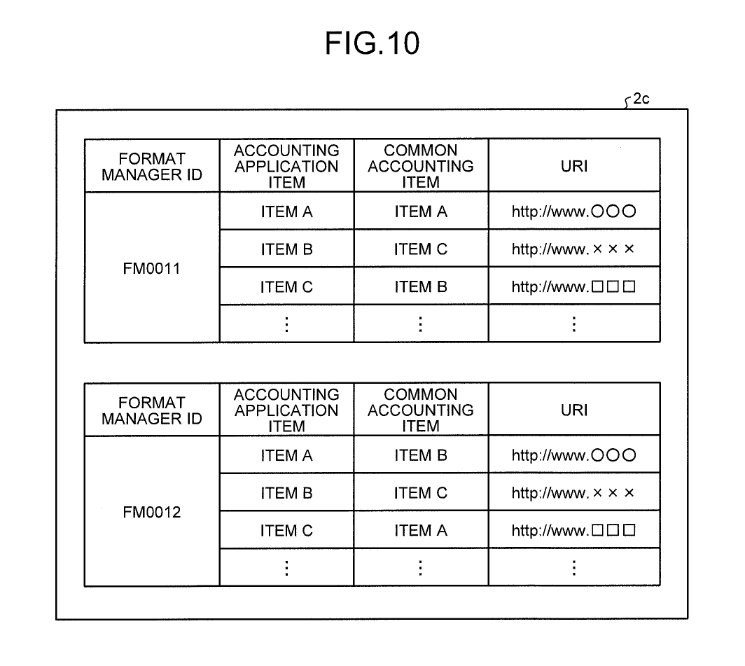

Here, the data structure of the attached information 1c is the same as that in FIG. 5. The data structure of the application management information 1d is the same as that in FIG. 6. The format definition information 2c is information in which items included in the accounting data 2a, items included in the common accounting data, and URIs (Uniform Resource Identifiers) are associated with each other. Here, an item included in the accounting data 2a is represented as an accounting application item and an item included in the common accounting data is represented as a common accounting item. As illustrated in FIG. 10, in the format definition information 2c, the format manager ID, the accounting application items, the common accounting items, and the URIs are stored in association with each other. The relationship among the accounting application items, the common accounting items, and the URIs is different for each format manager ID.

The common data generator 121a compares the attached information 1c and the application management information 1d and determines the format manager ID corresponding to the application key of the attached information 1c. For example, when the application key of the attached information 1c is “AP0003”, the corresponding format manager ID is “FM0011”.

Subsequently, the common data generator 121a compares the format manager ID and the format definition information 2c and determines the relationship among the accounting application items, the common accounting items, and the URIs. For example, when the format manager ID is “FM0011”, the relationship among the accounting application items, the common accounting items, and the URIs is the relationship illustrated in the upper part of FIG. 10.

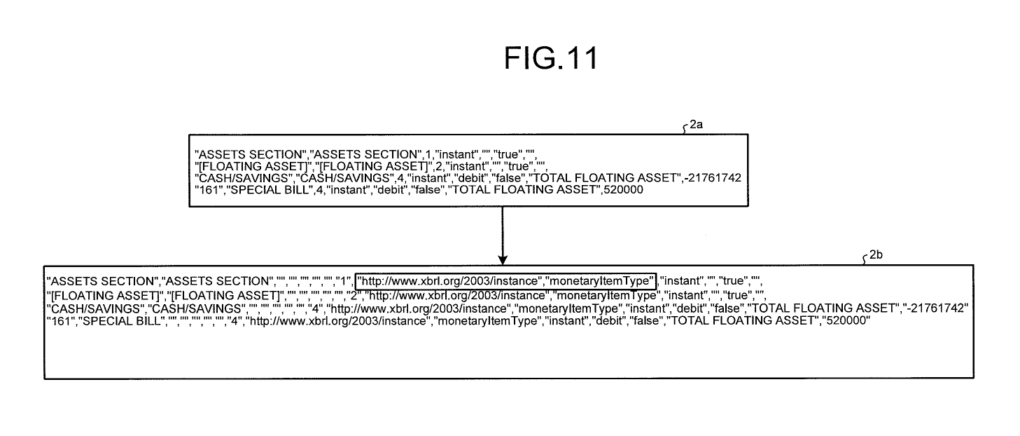

The common data generator 121a compares the relationship between the accounting application items and the common accounting items and the accounting data 2a and replaces the accounting application items by the common accounting items. Also, the common data generator 121a inserts the URIs related to the accounting application items into the accounting data 2a. The common data generator 121a performs the processing as described above, so that the accounting data 2a is converted into the common accounting data 2b. FIG. 11 is a diagram illustrating a relationship between the accounting data and the common accounting data. As illustrated in FIG. 11, for example, the URI “www.xbrl.org/2003/instance.” “monetaryItemType” is inserted into the common accounting data 2b. The URL includes “http://.” The accounting application items of the accounting data 2a which are not included in the format definition information 2c are not included in the common accounting data 2b.

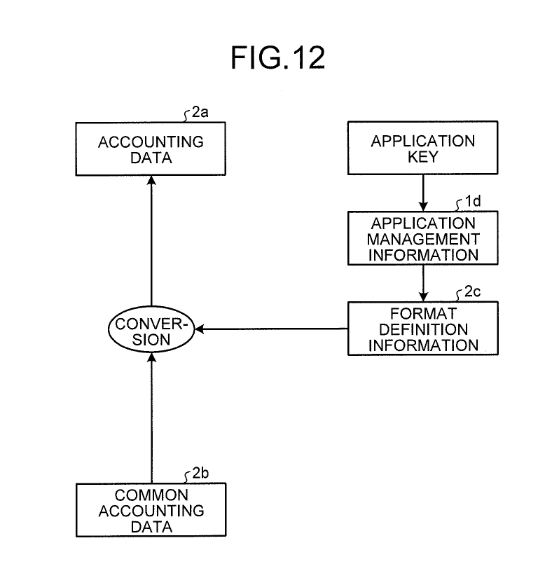

Next, the processing when the common data generator 121a converts the common accounting data into the accounting data will be described. This processing is the reverse processing of the processing for converting the accounting data 2a into the common accounting data 2b. FIG. 12 is a diagram (3) for explaining the processing of the common data generator. As illustrated in FIG. 12, the common data generator 121a converts the common accounting data 2b to the accounting data 2a on the basis of the application management information 1d and the format definition information 2c.

First, the common data generator 121a receives an application key of an accounting package desired by a user. The application key may be set in advance and received from outside. It is possible to generate the accounting data in a desired data format by specifying the application key. The common data generator 121a compares the application key and the application management information 1d and determines the format manager ID corresponding to the application key. For example, when the application key is “AP0003”, the corresponding format manager ID is “FM0011”.

Subsequently, the common data generator 121a compares the format manager ID and the format definition information 2c and determines the relationship among the accounting application items, the common accounting items, and the URIs. For example, when the format manager ID is “FM0011”, the relationship among the accounting application items, the common accounting items, and the URIs is the relationship illustrated in the upper part of FIG. 10.

The common data generator 121a compares the relationship between the accounting application items and the common accounting items and the accounting data 2a and replaces the common accounting items by the accounting application items. Also, the common data generator 121a extracts the URIs related to the accounting application items from the common accounting data 2b. The common data generator 121a performs the processing as described above, so that the common accounting data 2b is converted into the accounting data 2a.

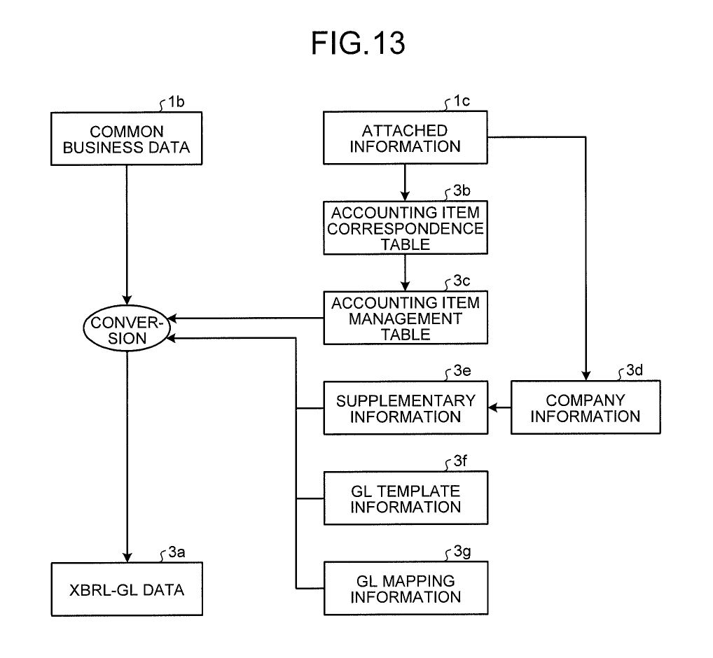

Next, the processing of the first format converter 121b illustrated in FIG. 3 will be specifically described. FIG. 13 is a diagram for explaining the processing of the first format converter. The first format converter 121b converts the common business data 1b into XBRL-GL data 3a on the basis of the attached information 1c, an accounting item correspondence table 3b, an accounting item management table 3c, company information 3d, supplementary information 3e, GL template information 3f, and GL mapping information 3g.

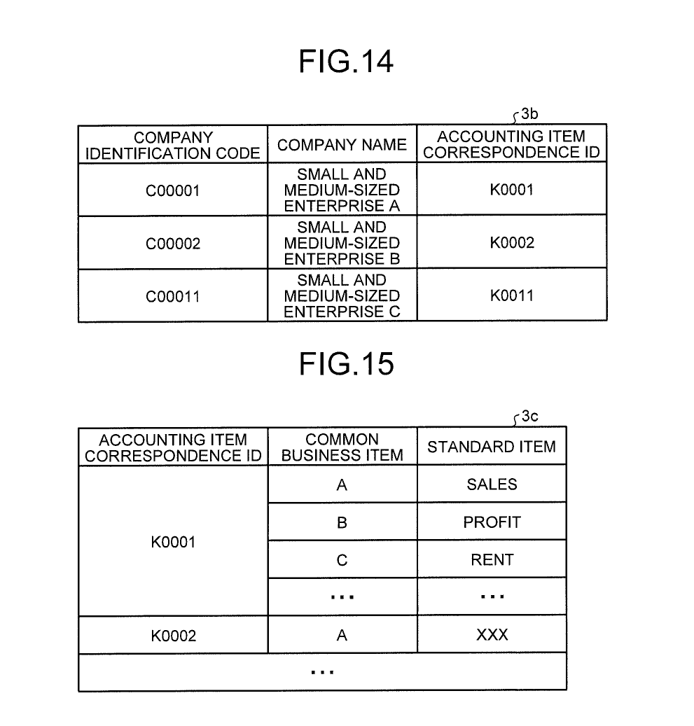

The data structure of the attached information 1c is the same as that in FIG. 5. The accounting item correspondence table 3b is a table for storing a company identification code and an accounting item correspondence ID in association with each other. FIG. 14 is a diagram illustrating a data structure of the accounting item correspondence table. As illustrated in FIG. 14, the accounting item correspondence table 3b stores a company identification code, a company name, and an accounting item correspondence ID in association with each other. The accounting item correspondence ID is used to refer to the accounting item management table 3c.

The accounting item management table 3c is information in which the common business items and items of the XBRL-GL data 3a are associated with each other. Here, the items of the XBRL-GL data 3a are represented as standard items. FIG. 15 is a diagram (1) illustrating a data structure of the accounting item management table. As illustrated in FIG. 15, the accounting item management table 3c stores the accounting item correspondence ID, the common business items, and the standard items in association with each other. The relationship between the common business items and the standard items is different for each accounting item correspondence ID.

The company information 3d stores various information related to each company. For example, the company information 3d stores company related information, Sheet information, Column information, and the like in association with the company identification code. The company related information includes, for example, a schema name space, a display link link base system identifier, and the like. The Sheet information includes information specifying validity of overwriting display link, an extended link role, and the like. The Column information includes the number of effective decimal digits, an aggregation period, a context filter, and the like.

The supplementary information 3e includes the company related information of the company information 3d, the Sheet information, and the Column information corresponding to the company identification code of the attached information 1c. The GL template information 3f corresponds to a template of the XBRL-GL data 3a. The GL mapping information 3g indicates a position of the GL template information 3f into which information corresponding to the standard items are inserted.

The first format converter 121b compares the attached information 1c and the accounting item correspondence table 3b and determines the accounting item correspondence ID corresponding to the company identification code of the attached information 1c. For example, when the company identification code of the attached information 1c is “C00001”, the corresponding accounting item correspondence ID is “K0001”.

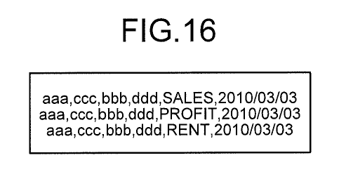

The first format converter 121b compares the accounting item correspondence ID and the accounting item management table 3c and determines the relationship between the common business items and the standard items. The first format converter 121b compares the relationship between the common business items and the standard items and the common business data 1b and replaces the common business items by the standard items. The common business data in which the common business items are replaced by the standard items is represented as intermediate common business data. FIG. 16 is a diagram illustrating a data structure of the intermediate common business data.

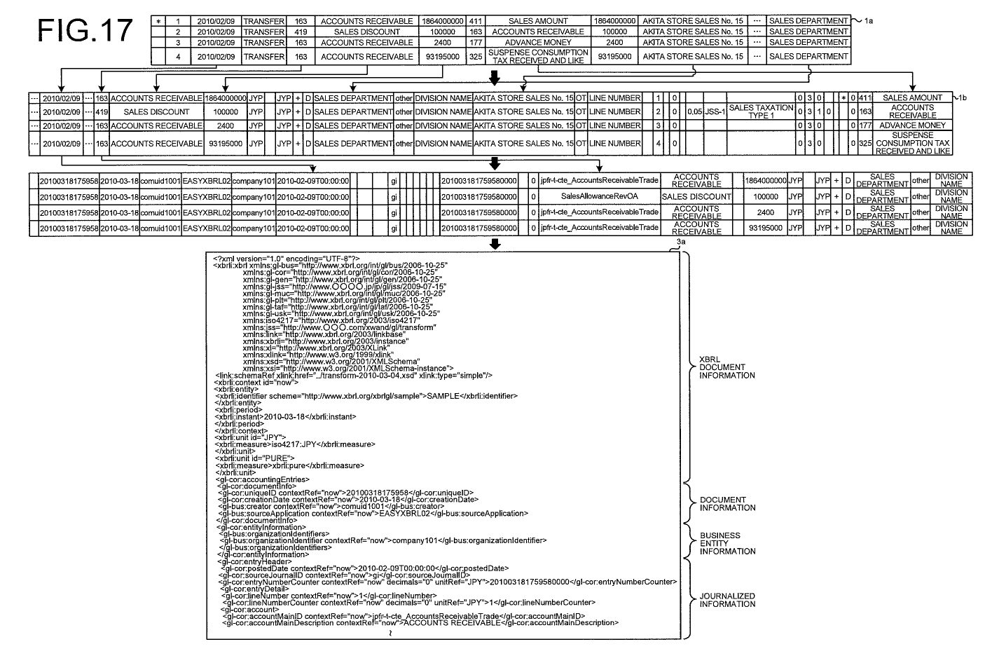

The first format converter 121b refers to the GL mapping information 3g and inserts the intermediate common business data into a corresponding position in the GL template information 3f. The first format converter 121b generates the XBRL-GL data 3a by adding the supplementary information 3e to the GL template information 3f into which the intermediate common business data is inserted. FIG. 17 is a diagram illustrating the relationship among the business data, the common business data, the intermediate common business data, and the XBRL-GL data. The XBRL-GL data includes XBRL document information, document information, business entity information, and journalized information. The journalized information includes credit side specific journalized data and debit side specific journalized data.

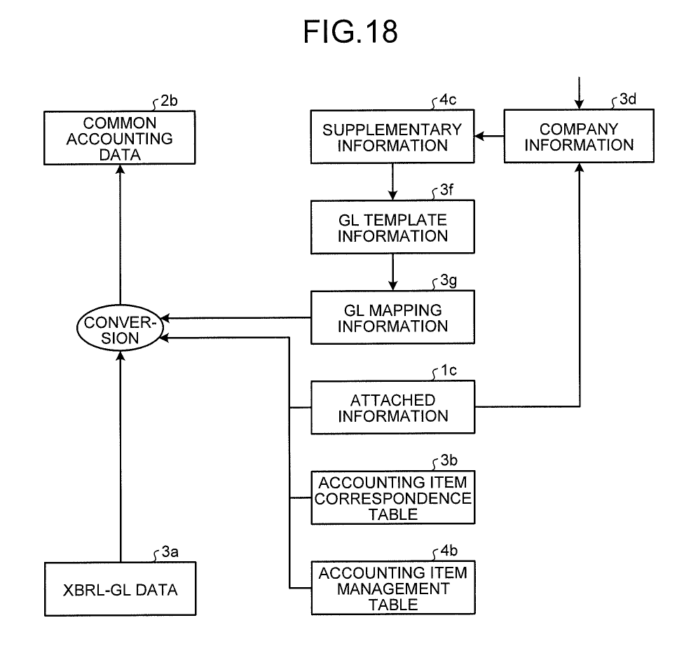

Next, the processing of the second format converter 121c illustrated in FIG. 3 will be specifically described. FIG. 18 is a diagram for explaining the processing of the second format converter. The second format converter 121c converts the XBRL-GL data 3a into the common accounting data 2b on the basis of the attached information 1c, the accounting item correspondence table 3b, the company information 3d, an accounting item management table 4b, supplementary information 4c, the GL template information 3f, and the GL mapping information 3g.

The second format converter 121c compares the attached information 1c and the accounting item correspondence table 3b and determines the accounting item correspondence ID corresponding to the company identification code of the attached information 1c. For example, when the company identification code of the attached information 1c is “000011”, the corresponding accounting item correspondence ID is “K0011”.

The second format converter 121c compares the accounting item correspondence ID and the accounting item management table 4b and determines the relationship between the common accounting items and the standard items. The second format converter 121c refers to the GL mapping information 3g, extracts the common accounting data 2b from the XBRL-GL data 3a, and converts the standard items of the common accounting data 2b into the common accounting items. By performing such a processing, the second format converter 121c converts the XBRL-GL data 3a into the common accounting data 2b.

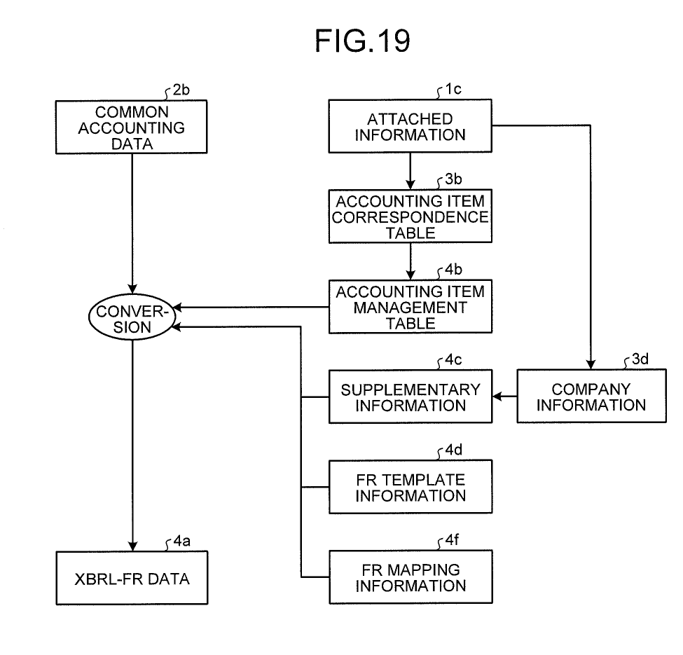

Next, the processing of the third format converter 121d illustrated in FIG. 3 will be specifically described. FIG. 19 is a diagram for explaining the processing of the third format converter. The third format converter 121d converts the common accounting data 2b into XBRL-FR data 4a on the basis of the attached information 1c, the accounting item correspondence table 3b, the company information 3d, the accounting item management table 4b, the supplementary information 4c, FR template information 4d, and FR mapping information 4f.

The data structure of the attached information 1c is the same as that in FIG. 5. The data structure of the accounting item correspondence table 3b is the same as that in FIG. 15. The company information 3d is the same as the company information 3d described in FIG. 13.

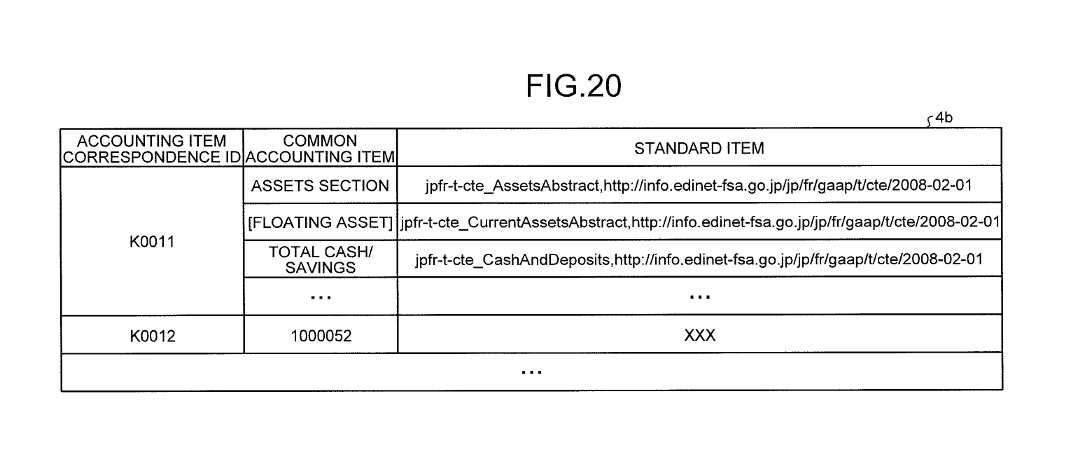

The accounting item management table 4b is information in which the common accounting items and items of the XBRL-FR data 4a are associated with each other. Here, the items of the XBRL-FR data 4a are represented as standard items. FIG. 20 is a diagram (2) illustrating a data structure of the accounting item management table. As illustrated in FIG. 20, the accounting item management table 4b stores the accounting item correspondence ID, the common accounting items, and the standard items in association with each other. The relationship between the common accounting items and the standard items is different for each accounting item correspondence ID.

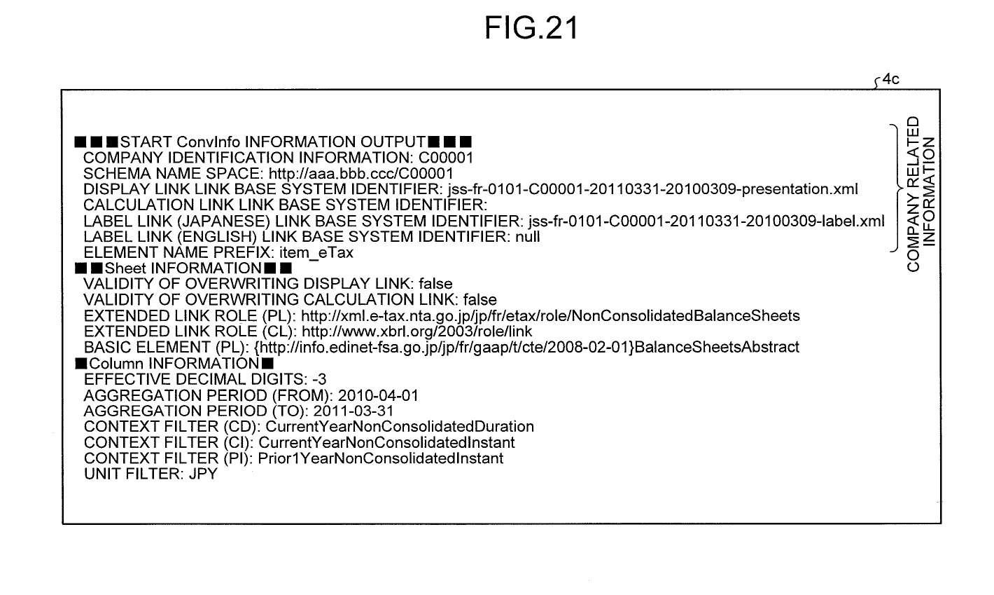

The supplementary information 4c includes the company related information of the company information 3d, the Sheet information, and the Column information corresponding to the company identification code of the attached information 1c. FIG. 21 is a diagram illustrating a data structure of the supplementary information. As illustrated in FIG. 21, the supplementary information 4c includes the company related information, the Sheet information, and the Column information.

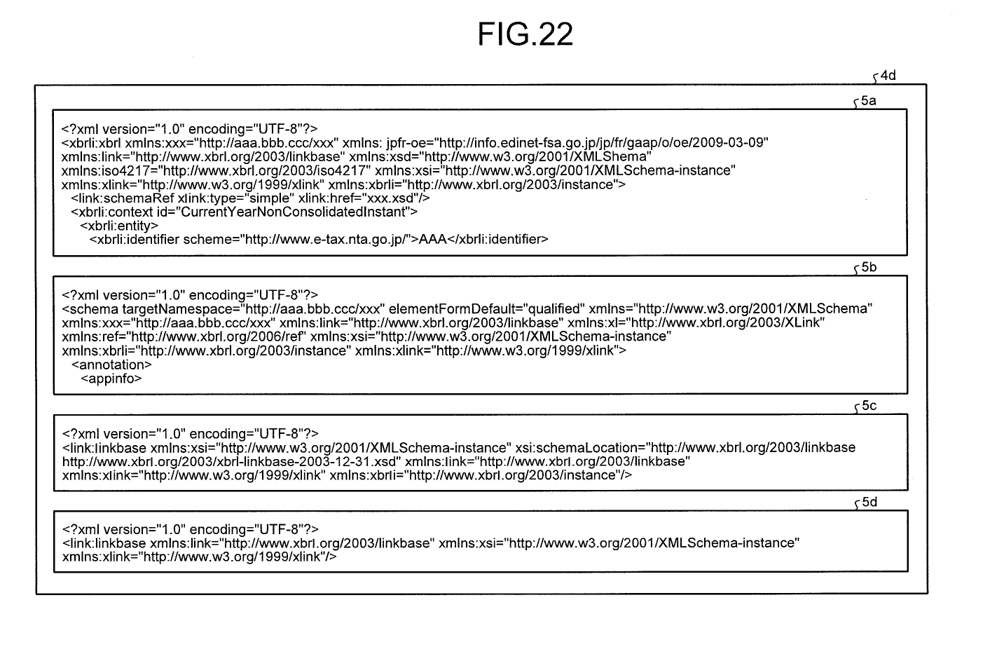

The FR template information 4d corresponds to a template of the XBRL-FR data 4a. FIG. 22 is a diagram illustrating a data structure of the FR template information. As illustrated in FIG. 22, the FR template information 4d includes a template instance 5a, a template taxonomy schema 5b, a template taxonomy label 5c, and a template taxonomy presentation 5d. The template instance 5a defines a part in which a numerical value is inputted. The template taxonomy schema 5b defines various words and phrases. The template taxonomy label 5c explains words and phrases in detail. The template taxonomy presentation 5d defines a position on a presentation.

The FR mapping information 4f indicates a position of the FR template information 4d into which information corresponding to the standard items are inserted.

The third format converter 121d compares the attached information 1c and the accounting item correspondence table 3b and determines the accounting item correspondence ID corresponding to the company identification code of the attached information 1c. For example, when the company identification code of the attached information 1c is “C00011”, the corresponding accounting item correspondence ID is “K0011”.

The third format converter 121d compares the accounting item correspondence ID and the accounting item management table 4b and determines the relationship between the common accounting items and the standard items. The third format converter 121d compares the relationship between the common accounting items and the standard items and the common accounting data 2b and replaces the common accounting items by the standard items.

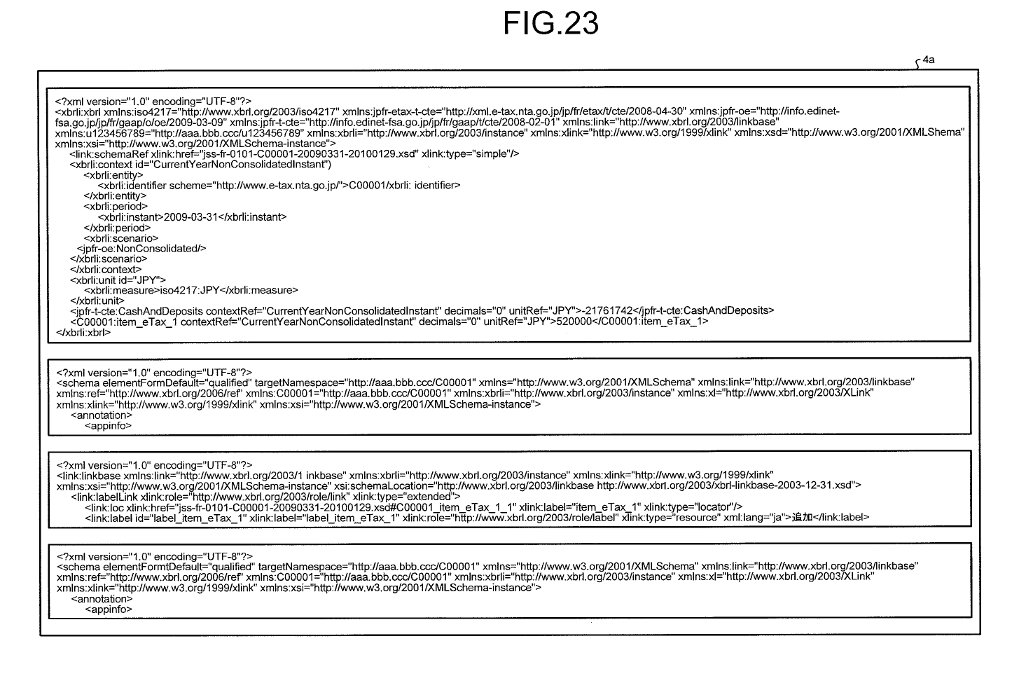

After replacing the common accounting items by the standard items, the third format converter 121d refers to the FR mapping information 4f and inserts the common accounting data 2b into a corresponding position in the FR template information 4d. The third format converter 121d generates the XBRL-FR data 4a by adding the supplementary information 4c to the FR template information 4d into which the common accounting data 2b is inserted. FIG. 23 is a diagram illustrating a data structure of the XBRL-FR data. The accounting application items of the accounting data 2a which are not included in the format definition information 2c are inserted into the XBRL-FR data 4a as extended accounting items.

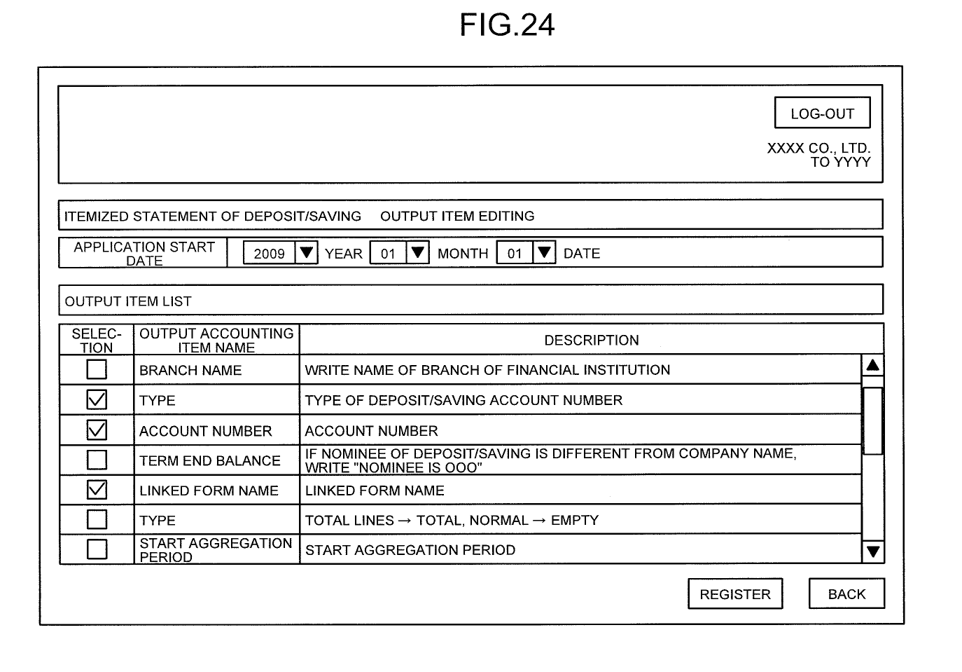

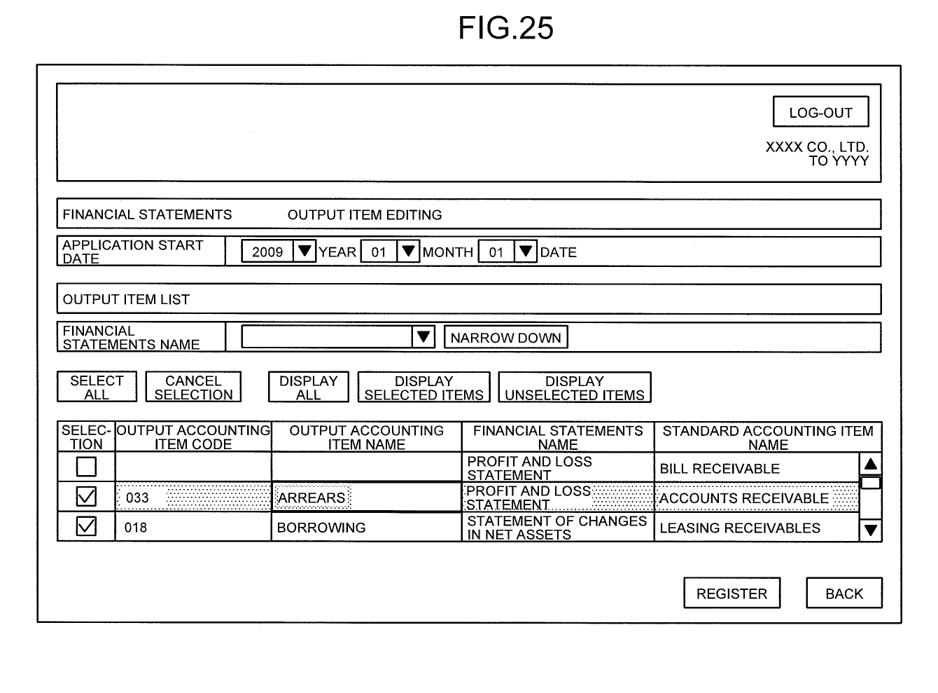

Next, a screen which the financial institution linkage function unit 123 causes the financial institution terminal 80 to display will be described. FIGS. 24 and 25 are diagrams illustrating an example of a screen outputted by the financial institution linkage function unit. The financial institution linkage function unit 123 causes the financial institution terminal 80 to display the screen illustrated in FIG. 24. The financial institution linkage function unit 123 searches for data corresponding to checked output accounting items from the XBRL-FR table and transmits a search result to the financial institution terminal 80. When the order of the output accounting items is specified, the financial institution linkage function unit 123 changes the order of data corresponding to the output accounting items according to the specified order and transmits the search result to the financial institution terminal 80.

The financial institution linkage function unit 123 may change an accounting item name to an accounting item name desired by the financier, and then transmit the data of the XBRL-FR table 122b to the financial institution terminal 80. For example, the financial institution linkage function unit 123 causes the financial institution terminal 80 to display the screen illustrated in FIG. 25. In the example illustrated in FIG. 25, a standard accounting item name “accounts receivable” of “profit and loss statement” of a financial statements name is set to “arrears”. In this case, the financial institution linkage function unit 123 searches for data corresponding to the standard accounting item name “accounts receivable” of the “profit and loss statement” of the financial statements name from the XBRL-FR table, sets the accounting item name of the searched data to “arrears”, and transmits the data to the financial institution terminal 80.

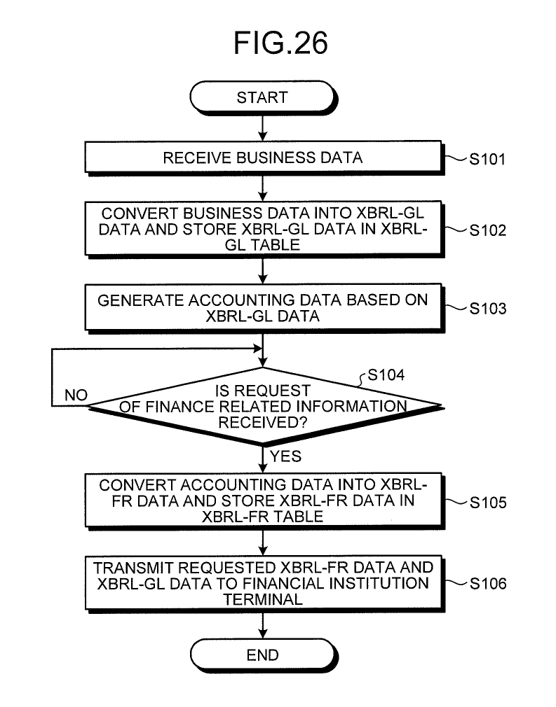

Next, the processing procedure of the XBRL management device 100 will be described. FIG. 26 is a flowchart illustrating the processing procedure of the XBRL management device. For example, the processing illustrated in FIG. 26 is performed when the XBRL management device 100 receives business data from the common portal 90.

As illustrated in FIG. 26, the XBRL management device 100 receives business data from the common portal 90 (step S101). The XBRL management device 100 converts the business data into the XBRL-GL data and stores the XBRL-GL data in the XBRL-GL table 122a (step S102). Then, the XBRL management device 100 generates the accounting data on the basis of the XBRL-GL data (step S103).

The XBRL management device 100 determines whether or not the XBRL management device 100 receives a request of finance related information from the financial institution terminal 80 (step S104). If the XBRL management device 100 does not receive the request of finance related information (step S104, No), the XBRL management device 100 proceeds to step S104 again.

On the other hand, when the XBRL management device 100 receives the request of finance related information (step S104, Yes), the XBRL management device 100 converts the accounting data into the XBRL-FR data and stores the XBRL-FR data in the XBRL-FR table 122b (step S105). Then, the XBRL management device 100 transmits the XBRL-FR data and the XBRL-GL data which are requested to the financial institution terminal 80 (step S106). At step S106, the XBRL management device 100 transmits other accompanying information to the financial institution terminal 80. The other accompanying information includes information of a copy of a bankbook of another financial institution and a checklist of the licensed tax accountant.

In addition to the processing illustrated in FIG. 26, there is a route through which the financial data is transmitted to the financial institution terminal 80. For example, the financial data directly inputted from the user terminal 60 is temporarily held by the XBRL management device 100. Then, responding to the request from the financial institution terminal 80, the XBRL management device 100 transmits the directly inputted financial data to the financial institution terminal 80.

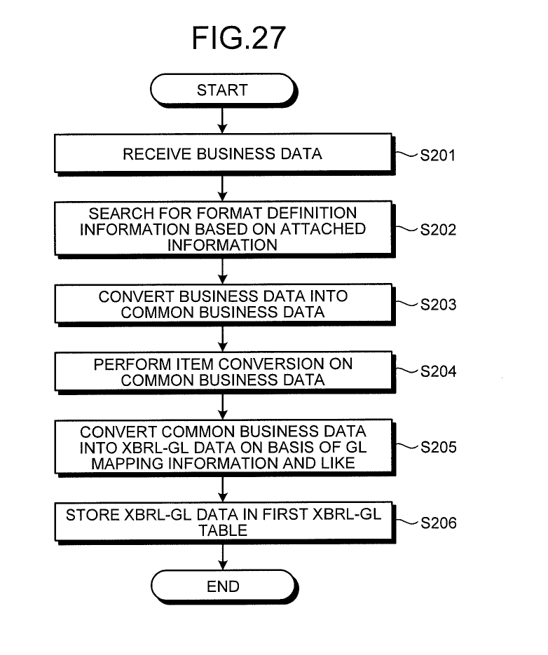

Next, the procedure for converting the business data into the XBRL-GL data will be described. FIG. 27 is a flowchart illustrating the procedure for converting the business data into the XBRL-GL data. For example, the processing illustrated in FIG. 27 is performed when the business data is received from the common portal 90.

As illustrated in FIG. 27, the common data generator 121a receives the business data (step S201) and searches for the format definition information based on the attached information (step S202). The common data generator 121a converts the business data into the common business data (step S203).

The first format converter 121b performs item conversion on the common business data (step S204). Then, the first format converter 121b converts the common business data into the XBRL-GL data on the basis of the GL mapping information and the like (step S205) and stores the XBRL-GL data in the XBRL-GL table 122a (step S206).

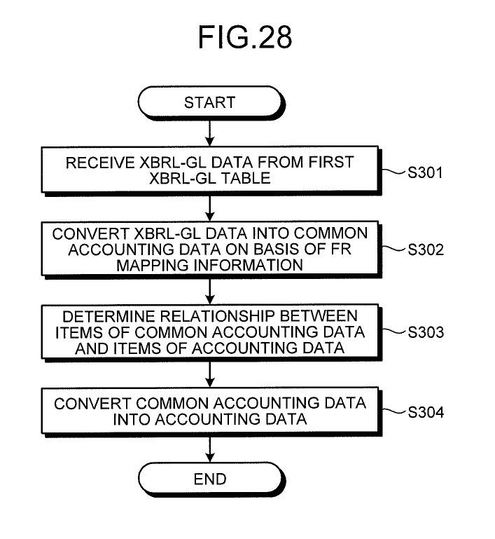

Next, the procedure for converting the XBRL-GL data into the accounting data will be described. FIG. 28 is a flowchart illustrating the procedure for converting the XBRL-GL data into the accounting data. For example, the processing illustrated in FIG. 28 is performed when the XBRL-GL data is stored in the XBRL-GL table 122a.

As illustrated in FIG. 28, the second format converter 121c receives the XBRL-GL data from the XBRL-GL table 122a (step S301) and converts the XBRL-GL data into the common accounting data on the basis of the FR mapping information (step S302).

The common data generator 121a determines the relationship between the items of the common accounting data and the items of the accounting data (step S303) and converts the common accounting data into the accounting data (step S304).

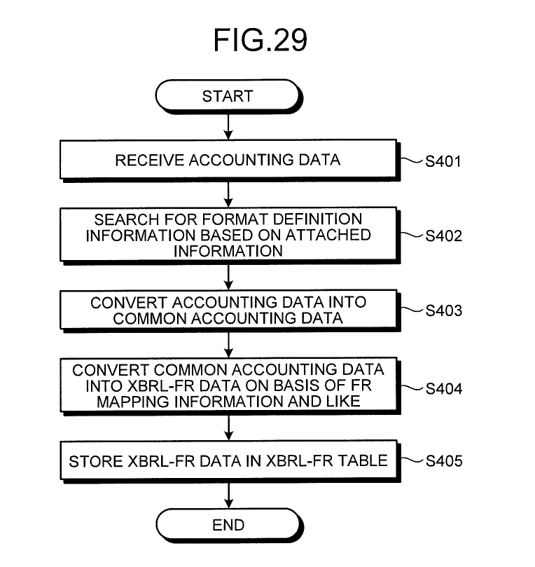

Next, the procedure for converting the accounting data into the XBRL-FR data will be described. FIG. 29 is a flowchart illustrating the procedure for converting the accounting data into the XBRL-FR data. For example, the processing illustrated in FIG. 29 is performed when a request of finance related information of a predetermined company is received from the financial institution terminal 80.

As illustrated in FIG. 29, the common data generator 121a receives the accounting data (step S401) and searches for the format definition information based on the attached information (step S402). The common data generator 121a converts the accounting data into the common accounting data (step S403).

The third format converter 121d converts the common accounting data into the XBRL-FR data on the basis of the FR mapping information and the like (step S404) and stores the XBRL-FR data in the XBRL-FR table 122b (step S405). The financial institution linkage function unit 123 transmits the XBRL-FR data and the XBRL-GL data which are stored in the XBRL-FR table 122b and the XBRL-GL table 122a to the financial institution terminal 80.

As described above, the XBRL management device 100 integrally manages the business data and the accounting data by the linkage according to the standard items of the XBRL and provides various finance related information to a company. Therefore, by using the XBRL management device 100, the financier can efficiently obtain information of the financial condition of the company and other supplementary information to finance the company (a copy of a bankbook of another bank, a checklist of a licensed tax accountant, and the like), so that the financier can quickly determine whether or not to finance the company.

According to the XBRL management device 100, it is possible to absorb differences of data formats and usages of individual accounting data of each accounting software package, such as differences of data formats of the business data uniquely generated by companies and differences of meanings of account items. Therefore, the company can easily convert the business data into the accounting data.

The XBRL management device 100 controls the linkage in which the linkage function unit 121 generates the accounting data after converting the business data into the XBRL data and the linkage in which the linkage function unit 121 converts the accounting data into the XBRL data format. Therefore, it is possible to guarantee the linkage in which the accounting data is generated from the business data, so that the accounting data is prevented from being falsified. Therefore, the financial condition of the company can be clarified.

The XBRL management device 100 converts the accounting data into XBRL format data and provides the converted data to the financial institution terminal 80. The converted data corresponds to the data format of the system used by the financier to analyze finance. Therefore, the financier does not need to convert the format of the accounting data into a standard data format as in the conventional manner, so that it is possible to reduce input cost and input error.

The XBRL management device 100 integrally manages the business data, the accounting data, and the like. Therefore, by using the XBRL management device 100, the company can reduce data arrangement cost for performing mandatory publication of financial statements and cost for electronically continuing and distributing the publication.

When using the XBRL management device 100, it is possible to convert the XBRL-GL data stored in the XBRL-GL table 122a into various accounting data. Therefore, the company can easily change the current accounting package to another accounting package.

The XBRL management device 100 notifies the financial institution terminal 80 of finance related information of the company along with an examination result of a licensed tax accountant. Therefore, the financier can smoothly determine whether or not to finance the company.

The XBRL management device 100 stores the XBRL-GL tables 122a and the XBRL-FR table 122b in the storage unit 122 and causes another terminal to be able to access the tables. Therefore, it is possible to easily perform data collection and management job for economic statistics work by a government office or a research institute.

The XBRL management device 100 causes the financier to be able to browse not only the “financial statements”, but also the “trial balance” and the “itemized statement”. The content of the trial balance and the itemized statement is the base of the content of the financial statements. Therefore, when the financier refers to the trial balance and the itemized statement, the financier can determine whether or not the content of the financial statements is appropriate.

When accounting data acquired from an external accounting software application includes data of a trial balance and an itemized statement in addition to financial statements, the first format converter 121b generates the XBRL-GL table 122a from the data of the calculating table and the itemized statement included in the accounting data. On the other hand, the third format converter 121d generates the XBRL-FR table 122b from the data of the financial statements included in the accounting data.

By the way, the XBRL management device 100 can also be realized by mounting the functions of the XBRL management device 100 on an information processing device such as a known personal computer or a known workstation.

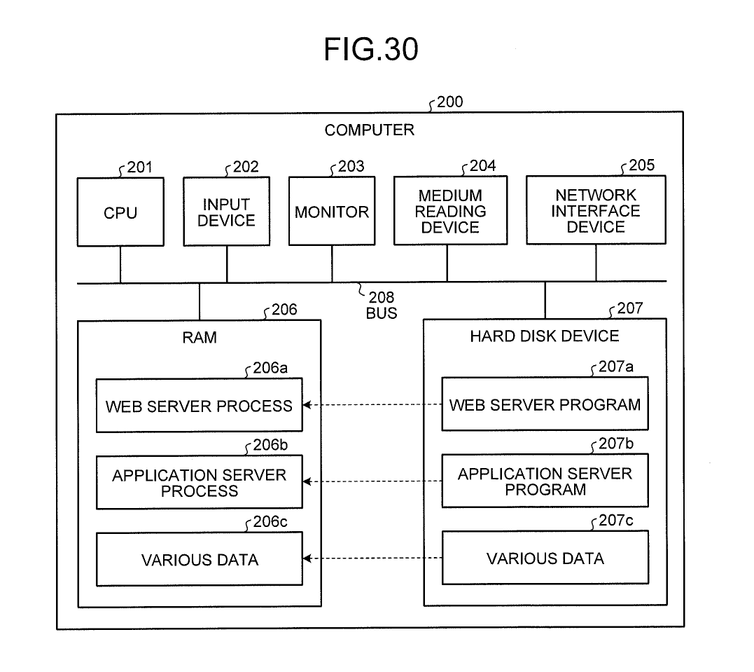

FIG. 30 is a diagram illustrating a hardware configuration of a computer that configures the XBRL management device according to the embodiment. As illustrated in FIG. 30, a computer 200 includes a CPU 201 which performs various calculation processings, an input device 202 which receives data input from a user, and a monitor 203. Also, the computer 200 includes a medium reading device 204 which reads a program and the like from a storage medium and a network interface device 205 which transmits and receives data to and from another computer through a network. Also, the computer 200 includes a RAM (Random Access Memory) 206 which temporarily stores various information and a hard disk device 207. The devices 201 to 207 are connected to a bus 208.

The hard disk device 207 stores a web server program 207a and an application server program 207b which have the same function as that of the XBRL management device 100. The hard disk device 207 also stores various data 207c corresponding to the data in the storage unit 122 in FIG. 3.

The CPU 201 reads the web server program 207a and the application server program 207b and develops the web server program 207a and the application server program 207b on the RAM 206. Thereby, the web server program 207a functions as a web server process 206a and the application server program 207b functions as an application server process 206b. The web server process 206a corresponds to the web server unit 110 in FIG. 3. The application server process 206b corresponds to the application server unit 120 in FIG. 3. The CPU 201 reads the various data 207c stored in the hard disk device 207 and stores the various data 207c in the RAM 206.

The web server process 206a performs an SSO authentication process and a relay process. The application server process 206b manages the business data and the accounting data in the XBRL data format by using various data 206c.

The web server program 207a and the application server program 207b do not necessarily need to be stored in the hard disk device 207. The computer 200 may read the web server program 207a and the application server program 207b stored in a storage medium such as a CD-ROM and execute the web server program 207a and the application server program 207b. Also, the web server program 207a and the application server program 207b may be stored in a storage device on a public line, the Internet, a LAN (Local Area Network), or a WAN (Wide Area Network) and the computer 200 may read the web server program 207a and the application server program 207b from the storage device and execute the web server program 207a and the application server program 207b.

According to the present invention, it is possible to uniformly process company-unique finance related information, so that there is an effect that the financier can quickly and appropriately finance the company.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A financial data processing device comprising:
a storage device stores items included in data of financial statements, a trial balance, and an itemized statement outputted from each of accounting software applications and common items among a plurality of accounting software applications in association with each other; and
a processor coupled to the storage devices, wherein the processor executes a process comprising:
generating common data obtained by converting items included in data of financial statements, a trial balance, and an itemized statement outputted from one accounting software application of the plurality of accounting software applications into common items among the plurality of accounting software applications and which are stored in the storage device in association with items of the financial statements, the trial balance, and the itemized statement outputted from the one accounting software application;
converting the common data into XBRL-FR format financial statements, and an XBRL-GL format trial balance and an XBRL-GL format itemized statement, which are related to the financial statements, on the basis of a mapping table which indicates a relationship among a template of XBRL-FR format financial statements, a template of an XBRL-GL format trial balance and an XBRL-GL format itemized statement, and areas in which the common items are located on the templates; and
storing the XBRL-FR format financial statements, the XBRL-GL format trial balance, and the XBRL-GL format itemized statement in the storage device.

2. The financial data processing device according to claim 1, wherein the process further comprises converting items included in the financial statements, items included in the trial balance, and items included in the itemized statement into items notified from an external device; and notifying the external device of information including the financial statements and information including the trial balance and the itemized statement.

3. A financial data processing method comprising:
storing items included in data of financial statements, a trial balance, and an itemized statement outputted from each of accounting software applications and common items among a plurality of accounting software applications in association with each other in a storage device;
generating common data obtained by converting items included in data of financial statements, a trial balance, and an itemized statement outputted from one accounting software application of the plurality of accounting software applications into items which are common among the plurality of accounting software applications and which are stored in the storage device in association with items of the financial statements, the trial balance, and the itemized statement outputted from the one accounting software application;
converting the common data into XBRL-FR format financial statements, and an XBRL-GL format trial balance and an XBRL-GL format itemized statement, which are related to the financial statements, on the basis of a mapping table which indicates a relationship among a template of XBRL-FR format financial statements, a template of an XBRL-GL format trial balance and an XBRL-GL format itemized statement, and areas in which the common items are located on the templates; and
storing the XBRL-FR format financial statements, the XBRL-GL format trial balance, and the XBRL-GL format itemized statement in the storage device.

4. A computer-readable recording medium having stored therein a financial data processing program for causing a computer to execute:
storing items included in data of financial statements, a trial balance, and an itemized statement outputted from each of accounting software applications and common items among a plurality of accounting software applications in association with each other in a storage device;
generating common data obtained by converting items included in data of financial statements, a trial balance, and an itemized statement outputted from one accounting software application of the plurality of accounting software applications into items which are common among the plurality of accounting software applications and which are stored in the storage device in association with items of the financial statements, the trial balance, and the itemized statement outputted from the one accounting software application;
converting the common data into XBRL-FR format financial statements, and an XBRL-GL format trial balance and an XBRL-GL format itemized statement, which are related to the financial statements, on the basis of a mapping table which indicates a relationship among a template of XBRL-FR format financial statements, a template of an XBRL-GL format trial balance and an XBRL-GL format itemized statement, and areas in which the common items are located on the templates; and
storing the XBRL-FR format financial statements, the XBRL-GL format trial balance, and the XBRL-GL format itemized statement in the storage device.
